(19) United States
(12) Patent Application Publication
(10) Pub. No.: US 2026/0024509 A1
(43) Pub. Date: Jan. 22, 2026

(54) METHOD AND SYSTEM FOR COMMUNICATION

(71) Applicant: ASPEED Technology Inc., Hsinchu City (TW)

(72) Inventors: Ju-Yu Yu, Hsinchu City (TW); Chih-Ta Huang, Hsinchu City (TW); Yi-Hsuan Jen, Hsinchu City (TW); Chih-Hsueh Huang, Hsinchu City (TW); Bi-Ru Wu, Hsinchu City (TW); Chang-Hsuan Hsu, Hsinchu City (TW)

(73) Assignee: ASPEED Technology Inc., Hsinchu City (TW)

(21) Appl. No.: 18/822,301

(22) Filed: Sep. 2, 2024

(30) Foreign Application Priority Data
Jul. 22, 2024 (TW) 113127255

(51) Int. Cl. G09G 5/36

(52) U.S. Cl. CPC G09G 5/363; G09G 2360/18; G09G 2370/14

(57) ABSTRACT

The invention provides a communication method, including: generating a plurality of frames sequentially by a first device, determining a tag of each of the frames according to a rule, and sending the frames sequentially to a second device; establishing a valid receiving tag by the second device; calculating a difference between the tag of a first frame and the valid receiving tag when the second device receives the first frame; and determining to perform at least one of a plurality of operations according to the difference by the second device, wherein the operations include sending a reply frame to the first device, updating the valid receiving tag, and sending a resend frame to the first device.

### CROSS-REFERENCE TO RELATED APPLICATION

This application claims the priority benefit of Taiwan application serial no. 113127255, filed on Jul. 22, 2024. The entirety of the above-mentioned patent application is hereby incorporated by reference herein and made a part of this specification.

### BACKGROUND OF THE INVENTION

### Field of the Invention

The disclosure relates to a method and system for communication that may be operated according to a tag in a frame.

### Description of Related Art

Low-Voltage Differential Signaling (LVDS) is a physical layer technique used to reduce power consumption in high-speed data transmission. LVDS is commonly used for high-speed data communication within a computer system, such as on a printed circuit board, where LVDS provides a high-speed, low-power solution. The LVDS Tunneling Protocol and Interface (LTPI) defines some specifications configured to send LVDS signals from one location to another location over the network, and for protocol conversion and management between the locations. The existing LTPI does not have an error recovery mechanism, and the overhead of the frame is also greater, thus resulting in less throughput, both of which need to be solved.

### SUMMARY OF THE INVENTION

In order to solve the above issues, the disclosure provides a communication system and a communication method having the functions of error recovery and increasing throughput.

An embodiment of the invention provides a communication method adapted for a first device and a second device. The communication method includes: generating a plurality of frames sequentially by a first device, determining a tag of each of the frames according to a rule, and sending the frames sequentially to a second device; establishing a valid receiving tag by the second device; calculating a difference between the tag of a first frame and the valid receiving tag when the second device receives the first frame; and determining to perform at least one of a plurality of operations according to the difference by the second device, wherein the operations include sending a reply frame to the first device, updating the valid receiving tag, and sending a resend frame to the first device.

In some embodiments, the communication method further includes: establishing a command buffer by the first device and storing the frames sequentially in the command buffer; and in a case that the command buffer is full, the first device suspends generating the frames.

In some embodiments, a size of the command buffer is less than an overflow upper limit, and the overflow upper limit is determined according to a bit number of the tag.

In some embodiments, the rule is an increment or a decrement, and the communication method also includes: setting a tag in the reply frame equal to the tag of the first frame by the second device, sending the reply frame to the first device, and discarding the first frame in a case that the difference is a first value; and setting the tag in the reply frame equal to the tag of the first frame by the second device, sending the reply frame to the first device, and setting the valid receiving tag equal to the tag of the first frame in a case that the difference is a second value.

In some embodiments, the communication method further includes: modifying the valid receiving tag according to the rule by the second device to determine a tag of the resend frame and sending the resend frame to the first device in a case that the difference is within a value range excluding the first value and the second value.

In some embodiments, the communication method further includes: establishing a valid sending tag by the first device; and setting the valid sending tag equal to the tag of the reply frame and removing at least one of the frames in the command buffer according to the tag of the reply frame when the first device receives the reply frame.

In some embodiments, the communication method further includes: obtaining a second frame corresponding to the tag of the resend frame from the command buffer when the first device receives the resend frame; and sending the second frame to the second device by the first device.

In some embodiments, the communication method further includes: starting a timer by the first device when the first device sends one of the frames; resetting the timer when the first device receives the reply frame; and modifying the valid sending tag according to the rule to obtain a first tag, obtaining a second frame corresponding to the first tag from the command buffer, and sending the second frame to the second device when the timer indication has timed out.

In some embodiments, the frames conform to an Original Equipment Manufacturer (OEM) frame in a Low-Voltage Differential Signaling (LVDS) Tunneling

### Protocol and Interface (LTPI).

In some embodiments, each of the frames includes first fields and a second field, and the communication method further includes: setting the first fields in the first frame to record a write address and the second field in the first frame to record a data length when the first frame corresponds to a write command; and setting the first fields and the second field of a second frame sorted after the first frame in the frames to record write data.

In some embodiments, the communication method further includes: setting the first fields in the first frame to record a read address and the second field in the first frame to record a data length when the first frame corresponds to a read command; and sending a second frame to the first device by the second device, wherein first fields and a second field in the second frame record read data.

From another perspective, an embodiment of the disclosure provides a communication system, including: a first device configured to generate a plurality of frames sequentially and determine a tag of each of the frames according to a rule; and a second device communicatively connected to the first device. The first device is configured to send frames sequentially to the second device, and the second device is configured to establish a valid receiving tag. When the second device receives a first frame, the second device is configured to calculate a difference between the tag of the first frame and the valid receiving tag, the second device is configured to determine to perform at least one of a plurality of operations according to the difference, and the operations include sending a reply frame to the first device, updating the valid receiving tag, and sending a resend frame to the first device.

In some embodiments, the first device is configured to establish a command buffer and store the frames sequentially in the command buffer, and in a case that the command buffer is full, the first device is configured to suspend generating the frames.

In some embodiments, the rule is an increment or a decrement, and in a case that the difference is a first value, the second device is configured to set a tag of the reply frame equal to the tag of the first frame, send the reply frame to the first device, and discard the first frame. In a case that the difference is a second value, the second device is configured to set the tag in the reply frame equal to the tag of the first frame, send the reply frame to the first device, and set the valid receiving tag equal to the tag of the first frame.

In some embodiments, in a case that the difference is within a value range excluding the first value and the second value, the second device is configured to modify the valid receiving tag according to the rule to determine a tag of the resend frame and send the resend frame to the first device.

In some embodiments, the first device is configured to establish a valid sending tag, when the first device receives the reply frame, the first device is configured to set the valid sending tag equal to the tag of the reply frame and remove at least one of the frames in the command buffer according to the tag of the reply frame.

In some embodiments, when the first device receives the resend frame, the first device obtains a second frame corresponding to the tag of the resend frame from the command buffer, and sends the second frame to the second device.

In some embodiments, when the first device sends one of the frames, the first device is configured to start a timer. The first device receives the reply frame, and the first device is configured to reset the timer. When the timer indication has timed out, the first device modifies the valid sending tag according to the rule to obtain a first tag, obtains a second frame corresponding to the first tag from the command buffer, and sends the second frame to the second device.

In some embodiments, each of the frames includes first fields and a second field, and when the first frame corresponds to a write command, the first device is configured to set the first fields in the first frame to record a write address and the second field in the first frame to record a data length. For a second frame sorted after the first frame, the first device is configured to set the first fields and the second field of the second frame to record write data.

In some embodiments, when the first frame corresponds to a read command, the first device is configured to set the first fields in the first frame to record a read address and the second field in the first frame to record a data length. The second device is configured to send a second frame to the first device, and a plurality of first fields and at least one second field in the second frame record read data.

In order to make the aforementioned features and advantages of the disclosure more comprehensible, embodiments accompanied with figures are described in detail below.

### BRIEF DESCRIPTION OF THE DRAWINGS

FIG. 1 shows a schematic diagram of a communication system according to an embodiment.

FIG. 2 shows a schematic diagram of a certain aspect of a communication system according to an embodiment.

FIG. 3 shows a schematic diagram of a communication system and a bus according to an embodiment.

FIG. 4 shows a schematic diagram of a data structure of a frame according to an embodiment.

FIG. 5 shows a schematic diagram of various bits in a tag according to an embodiment.

FIG. 6 shows a schematic diagram of a finite state machine corresponding to a communication method according to an embodiment.

FIG. 7 shows a schematic diagram of a sending frame and a corresponding tag according to a first scenario.

FIG. 8 shows a schematic diagram of a sending frame and a corresponding tag according to a second scenario.

FIG. 9 shows a schematic diagram of a sending frame and a corresponding tag according to a third scenario.

FIG. 10 shows a schematic diagram of a sending frame and a corresponding tag according to a fourth scenario.

FIG. 11 shows a schematic diagram of a sending frame and a corresponding tag according to a fifth scenario.

FIG. 12 shows a schematic diagram of a sending frame and a corresponding tag according to a sixth scenario.

FIG. 13 shows a schematic diagram of a payload in a frame according to an embodiment.

FIG. 14 shows a timing diagram of sending a frame between two devices according to prior art.

FIG. 15 shows a timing diagram of sending a frame between two devices according to an embodiment.

FIG. 16 shows a flowchart of a communication method according to an embodiment.

### DESCRIPTION OF THE EMBODIMENTS

A portion of the embodiments of the disclosure is described in detail hereinafter with reference to figures. In the following, the same reference numerals in different figures should be considered to represent the same or similar elements. The embodiments are only a part of the invention, and do not disclose all possible implementation modes of the invention. Rather, the embodiments are merely examples of systems and methods within the scope of the invention.

The terms “first”, “second”, etc. used in this article do not specifically refer to the order or sequence, but are only used to distinguish elements or operations described with the same technical terms.

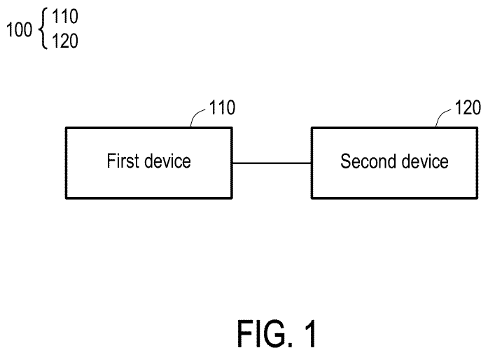

FIG. 1 shows a schematic diagram of a communication system according to an embodiment. Referring to FIG. 1, a communication system 100 includes a first device 110 and a second device 120, wherein the first device 110 may be communicatively connected to the second device 120 using any suitable wired or wireless communication means. In some embodiments, the first device 110 and the second device 120 are two devices in a computer system. The computer system may be a personal computer, a server, an industrial computer, etc. The first device 110 and the second device 120 may be independent circuits or circuits integrated in other computer elements.

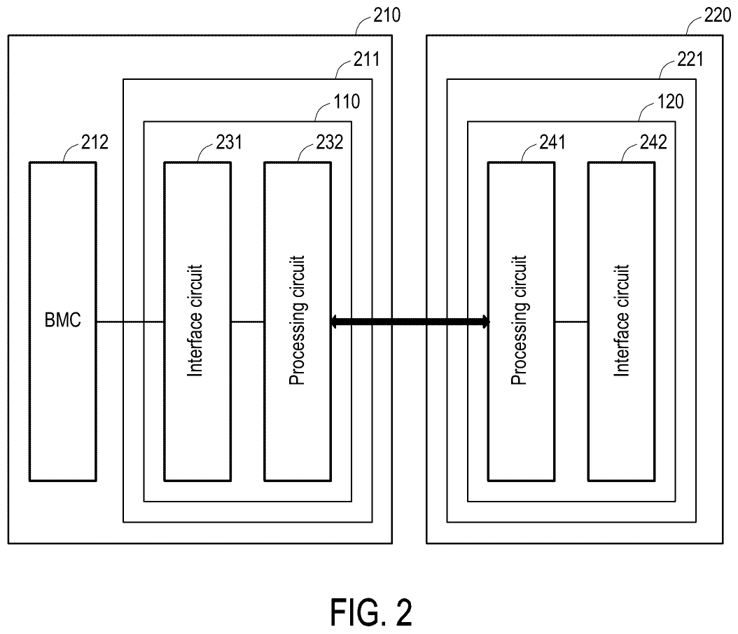

FIG. 2 shows a schematic diagram of a certain aspect of a communication system according to an embodiment. In the embodiment of FIG. 2, the first device 110 is one Complex Programmable Logic Device (CPLD) 211 included in a System Control Management (SCM) unit 210. The first device 110 includes an interface circuit 231 and a processing circuit 232. A baseboard management controller (BMC) 212 is communicatively connected to the interface circuit 231 via one Original Equipment Manufacturer (OEM) interface and sends commands to the interface circuit 231. The processing circuit 232 is electrically connected to the interface circuit 231, and obtains the commands via the interface circuit 231 to generate a plurality of frames.

Moreover, the second device 120 is included in one Field-Programmable Gate Array (FPGA) 221 in a Host Power Management (HPM) unit 220. The second device 120 includes a processing circuit 241 and an interface circuit 242. The processing circuit 241 is electrically connected to the interface circuit 242 to receive a frame. The interface circuit 242 communicates with other devices (not shown) via an OEM interface.

In the embodiment of FIG. 2, the communication between the first device 110 and the second device 120 complies with the Low-Voltage Differential Signaling (LVDS) specification. The frame generated by the first device 110 is an original equipment manufacturer (OEM) frame in LTPI. The first device 110 and the second device 120 exchange OEM frames with each other. It is worth noting that a data frame and an input and output frame are also defined in the LTPI specification. Other frames such as data frames, input and output frames are also sent between the first device 110 and the second device 120, and the frames are interleaved with each other. In addition, OEM frames are sent via OEM tunnels in the LTPI specification, and LTPI also allows the establishment of other tunnels, such as GPIO (General-Purpose Input/Output) tunnel, I2C (Inter-Integrated tunnel, Circuit) and UART (Universal Asynchronous Receiver/Transmitter) tunnel, data tunnel, etc., and the tunnels may also be established between the first device 110 and the second device 120 as needed.

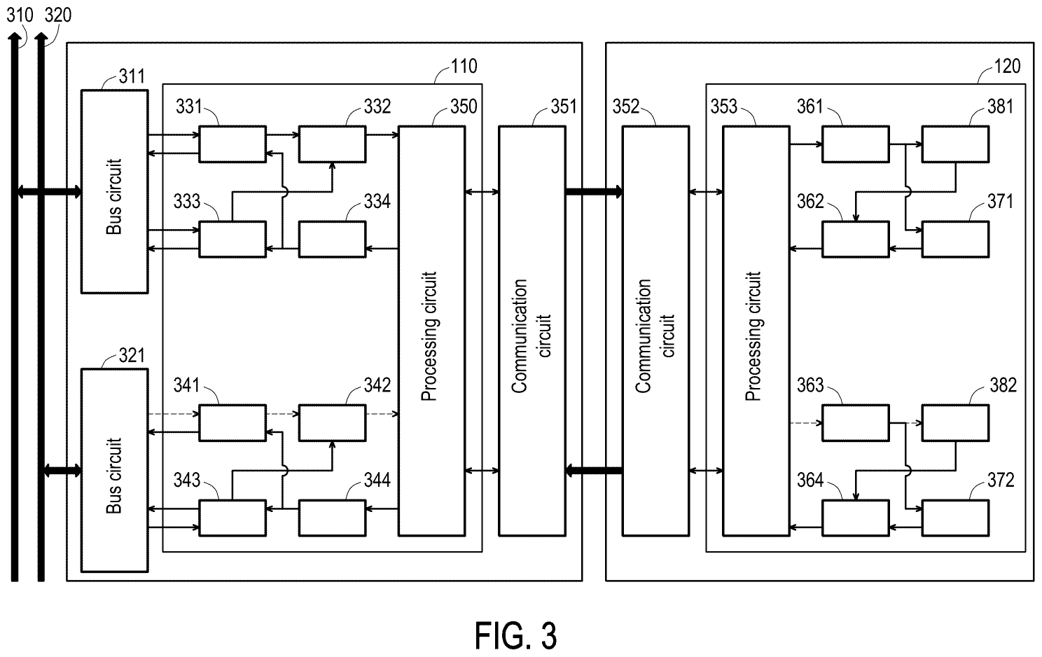

FIG. 3 shows a schematic diagram of a communication system and a bus according to an embodiment. Please refer to FIG. 3. In the embodiment of FIG. 3, a bus 310 and a bus 320 are also shown. The bus 310 is, for example, an Advanced High-performance Bus (AHB), and the bus 320 is, for example, a Memory Bus (Mbus). A bus circuit 311 is electrically connected to the bus 310 to send or receive bus data, and a bus circuit 321 is electrically connected to the bus 320 to send or receive bus data. The first device 110 includes a slave circuit 331, a conversion circuit 332, a master circuit 333, and a conversion circuit 334. The slave circuit 331 and the master circuit 333 are electrically connected to the bus circuit 311 and configured to send or receive bus data. The conversion circuit 332 is configured to convert the bus data into OEM data, and the OEM data is sent to the processing circuit 350. The conversion circuit 334 is configured to convert the OEM data into bus data, and then send the bus data to the slave circuit 331 or the master circuit 333. Similarly, the first device 110 also includes a slave circuit 341, a conversion circuit 342, a master circuit 343, and a conversion circuit 344. The circuits correspond to the bus 320. In some embodiments, the slave circuit 341 and the conversion circuit 342 are disabled, that is, not used.

After the processing circuit 350 generates frames according to the OEM data (including commands from other devices), a communication circuit 351 sends the frames to a communication circuit 352 and then to a processing circuit 353 in the second device 120. For example, the connection between the communication circuit 351 and the communication circuit 352 complies with the LTPI specification. The second device 120 includes conversion circuits 361 to 364, slave circuits 371 and 372, and master circuits 381 and 382. The circuit in the second device 120 is symmetrical to the circuit in the first device 110 and is not repeated here. In some embodiments, the slave circuit 382 and the conversion circuit 363 are disabled.

In particular, the processing circuit 350 and the processing circuit 353 implement one communication method using one tag in the frame to perform error recovery and may improve communication throughput. The structure of the frame is first explained below, and then the communication method is explained.

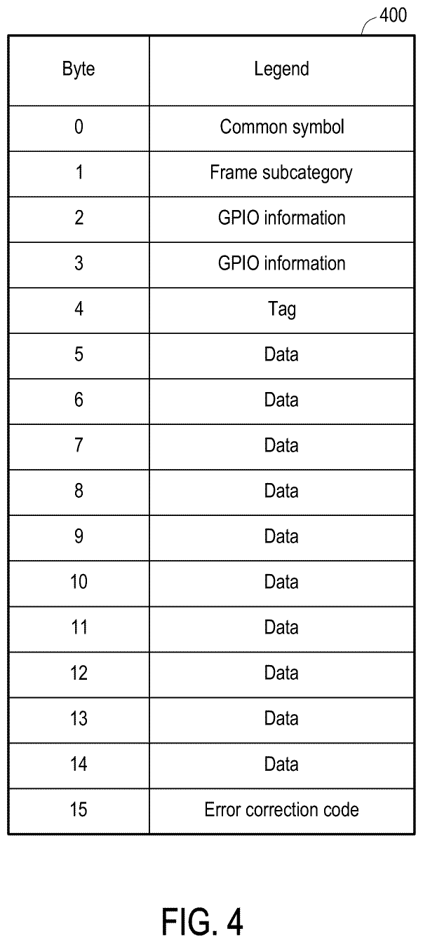

FIG. 4 shows a schematic diagram of a data structure of a frame according to an embodiment. In the embodiment of FIG. 4, a frame 400 includes 16 bytes, wherein the byte marked “0” records the common symbol configured to indicate the frame type, and the byte marked “1” records the frame subtype. The types and subtypes are defined in the LTPI specification. The bytes marked “2” and “3” record information about GPIO. The byte marked “4” records the tag. The bytes marked “5” to “14” are configured to record data. The byte marked “15” is configured to record the error checking code. In other embodiments, each frame may include more or less bytes, and the tags may be disposed at arbitrary locations.

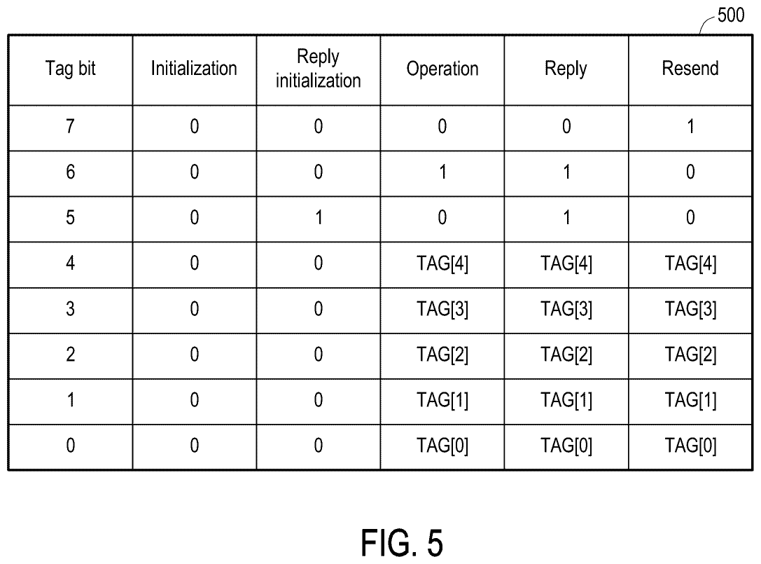

FIG. 5 shows a schematic diagram of various bits in a tag according to an embodiment. Please refer to a table 500 of FIG. 5. In the present embodiment, each tag includes 8 bits, wherein the bits marked “0” to “4” (also called tag bits TAG[0] to TAG[4]) are configured to represent the value of the tag, and the bits marked “5” to “7” are configured to represent the corresponding plurality of custom frame types. The custom frame types include initialization frame, reply initialization frame, operation frame, reply frame, and resend frame. For example, when the bits marked “5” to “7” are “000” respectively, the frame is an initialization frame, and so on. In addition, when the custom frame type belongs to the initialization frame and the reply initialization frame, the bits marked “0” to “4” have no meaning. There are 5 tag bits here, so the tag value ranges from 0 to 31. In other embodiments, each tag may include more or less bits, and the invention does not limit the size of the tags. For example, each tag may include 8 tag bits, and the bits representing the custom frame type may be recorded in other bytes of the frame.

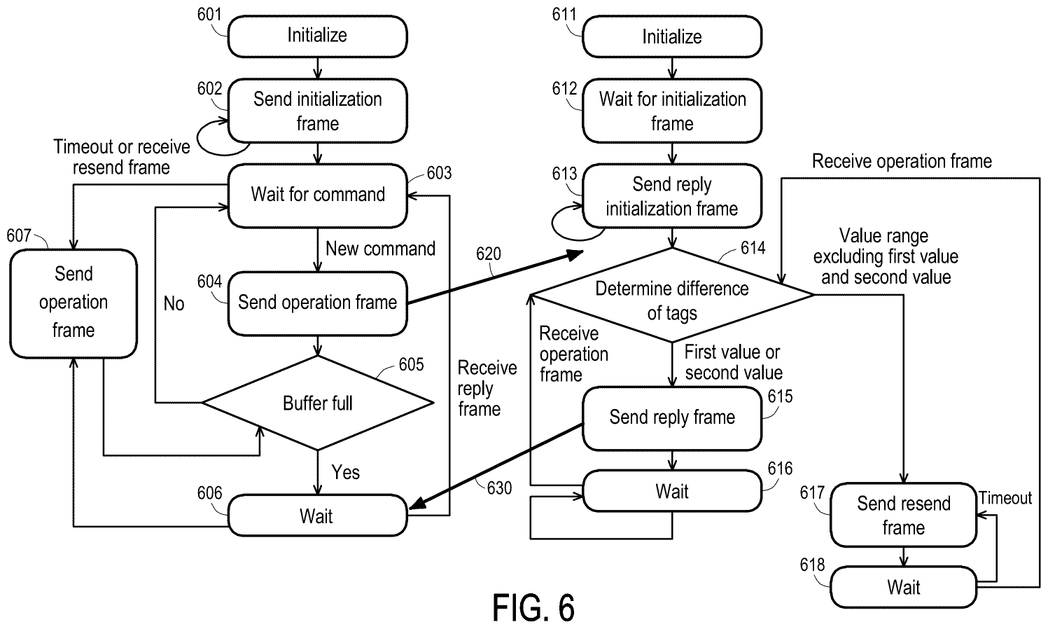

FIG. 6 shows a schematic diagram of a finite state machine corresponding to a communication method according to an embodiment. Referring to FIG. 1 and FIG. 6, states 601 to 607 represent the states of the first device 110 and the steps performed, and states 611 to 618 represent the states of the second device 120 and the steps performed. First, state 601 is the initial state, and state 602 is entered after the communication method is started. In state 602, the first device 110 continuously sends an initialization frame to the second device 120. As defined in FIG. 5, the last three bits of the tag in the initialization frame are “000”. Next, the first device 110 waits to receive a reply initialization frame from the second device 120.

Moreover, the second device 120 initially enters state 611, which is the initial state. Next, in state 612, the second device 120 waits to receive the initialization frame. After the initialization frame is received, the second device 120 enters state 613 and continuously sends the reply initialization frame to the first device 110.

After the reply initialization frame is received, the first device 110 enters state 603 and waits for a new command. For example, the command is issued by the baseboard management controller or by other devices on the bus. After the new command is received, the first device 110 enters state 604, generates a corresponding operation frame according to the command, and sends an operation frame 620 to the second device 120. As defined in FIG. 5, the last three bits of the tag in the operation frame are “010”. The operation frames may be configured to write or read data, and the invention does not limit the use of the operation frames. The first device 110 also establishes one command buffer and stores the generated operation frames in the command buffer. Next, state 605 is entered to determine whether the command buffer is full. In a case that the command buffer is not full, state 603 is returned. In a case that the first device 110 continues to receive a plurality of commands and the command buffer is not full, states 603 to 605 are repeated continuously, generating a plurality of operation frames sequentially. The operation frames are sent to the second device 120 sequentially, and the operation frames are stored in the command buffer sequentially.

Each operation frame includes a tag, and the first device 110 determines the tags in the operation frames according to a rule. The rule may be an increment or a decrement, and the invention is not limited thereto. For example, in a case that the rule is an increment, the tag of the first operation frame may be “0”. The tag of the second operation frame may be “1”, the tag of the third operation frame may be “2”, and so on. In a case that the rule is a decrement, the tag of the first operation frame may be “31”. The tag of the second operation frame may be “30”, the tag of the third operation frame may be “29”, and so on. For convenience of explanation, the following paragraphs use an increment as an example to continue the explanation.

When the second device 120 receives the operation frame in state 613, the second device 120 enters state 614. The second device 120 has established one valid receiving tag in advance. In state 614, the second device 120 calculates the difference between the tag (also called the first tag) in the received operation frame (also called the first frame) and the valid receiving tag. According to the difference, the second device 120 determines to perform at least one of the plurality of operations. The operations include sending a reply frame to the first device 110, updating the valid receiving tag, and sending a resend frame to the first device 110.

Since the tag of the operation frame is an increment, the second device 120 is expected to receive the tag of the increment. In a case that the difference calculated above meets expectations, the operation frame is not lost. At this time, the valid receiving tag may be updated (also incremented) and a reply frame is sent to the first device 110 to inform the currently received operation frame. In a case that the calculated difference is lower than expected, a duplicate operation frame is received. The second device 120 discards the received operation frame and sends the reply frame to the first device 110. In a case that the calculated difference is higher than expected, the operation frame sent by the first device 110 is lost, and a resend frame is sent to the first device 110 at this time. Via this method, the error recovery function may be achieved. Moreover, since the first device 110 does not need to wait to receive the reply frame after sending one operation frame, as long as the command buffer is not full, the next operation frame may be sent continuously to increase throughput.

Specifically, in a case that it is determined in state 614 that the difference between the received tag of the first frame and the valid receiving tag is a first value (for example, 0) or a second value (for example, 1), state 615 is entered. In state 615, the second device 120 sets the tag in the reply frame equal to the tag of the first frame and sends a reply frame 630 to the first device 110. In addition, when the difference is the first value, the second device 120 discards the first frame. When the difference is the second value, the second device 120 sets the valid receiving tag equal to the tag of the first frame. Then state 616 is entered to wait for an operation frame from the first device and state 614 is returned after the operation frame is received.

In a case that it is determined in state 614 that the difference of the tag is within a value range excluding the first value and the second value, state 617 is entered. This value range is, for example, greater than or equal to 2. In state 617, the second device 120 modifies the valid receiving tag according to the above rule to determine the tag of the sending frame. For example, when the rule is an increment, the valid receiving tag may be added by 1 to determine the tag of the resend frame. When the rule is a decrement, the valid receiving tag may be subtracted by 1 to determine the tag of the resend frame. Next, the second device 120 sends the resend frame to the first device 110 and enters state 618. In a case that a new operation frame is received in state 618, state 614 is returned. In a case that the wait time exceeds a preset time in state 618, state 617 is returned and the resend frame is sent to the first device 110 again.

In the embodiment in which the rule is a decrement, the first value is 0, the second value is −1, and the value range is less than or equal to −2. Different first values, second values, and value ranges may be set according to different rules.

Please return to the first device 110. In a case that it is determined in state 605 that the command buffer is full, the first device 110 suspends generating frames and enters state 606 to wait for the frame returned by the second device 120. The first device 110 establishes one valid sending tag to indicate that the second device 120 has confirmed the received operation frame. In a case that a reply frame is received in state 606, the first device 110 sets the valid sending tag to equal to the tag of the reply frame, and returns to state 603. Moreover, since the second device 120 receives the operation frame, the operation frame no longer needs to be stored in the command buffer. Therefore, at least one operation frame in the command buffer may be removed according to the tag of the reply frame. In an embodiment in which the rule is an increment, when the tag of the reply frame is N, the first device 110 removes all operation tags with tags less than or equal to N from the command buffer. In an embodiment in which the rule is a decrement, when the tag of the reply frame is N, the first device 110 removes all operation tags with tags greater than or equal to N from the command buffer.

In the present embodiment, since there are only 5 tag bits, the value of the tag ranges from 0 to 31. When the tag continues to increase until exceeding 31, the tag returns to the value 0 and continues to incrementally increase. This is called tag overflow. In a case that the second device 120 receives an operation frame with a tag of 0, and the valid receiving tag is 31, this is still be considered legitimate. At this time, the second device 120 enters state 615 and updates the valid receiving tag to 0. In a case that the command buffer is too large, an operation frame with a tag of 0 may still be in the command buffer when a tag overflow occurs, thus causing an error. Therefore, in some embodiments, the size of the command buffer may be set to be less than an overflow upper limit. The overflow upper limit is determined according to the bit number of the tag. In an embodiment, the overflow upper limit may be set to half of the number of values that the tag may represent. For example, in a case that the bit number of the tag is 5, the tag may only represent 32 values, and the overflow upper limit is set to 32/2=16.

In a case that the first device 110 receives a reply frame in state 603, although the reply frame is not switched to other states, the valid sending tag is set to equal to the tag of the reply frame, and the corresponding operation frame is removed from the command buffer according to the tag of the reply frame.

In a case that a resend frame is received in state 606, the first device 110 enters state 607 and obtains the second frame corresponding to the tag of the resend frame from the command buffer, and transmits the second frame to the second device 120, and then enters the state 605. For example, in a case that the tag of the resend frame is 2, an operation frame with a tag of 2 is obtained from the command buffer. Moreover, in a case that a resend frame is received in state 603, the first device 110 also enters state 607 and obtains the second frame corresponding to the tag of the resend frame from the command buffer, and transmits the second frame to the second device 120.

In an embodiment, the first device 110 may also set one timer. A value of the timer greater than a threshold value indicates timeout. When the first device 110 sends any operation frame in state 604, the first device 110 starts the timer (starts to increase the value thereof). When the first device 110 receives the reply frame (for example, when switching from state 606 to state 603), the timer is reset. When in state 603 and the timer indication has timed out, the first device 110 modifies the valid sending tag according to the rule to obtain one first tag. For example, when the rule is an increment, 1 may be added to the valid sending tag to obtain the first tag. In a case that the rule is a decrement, 1 may be subtracted from the valid sending tag. After the first tag is calculated, the first device 110 obtains the operation frame corresponding to the first tag from the command buffer and sends the operation frame to the second device 120.

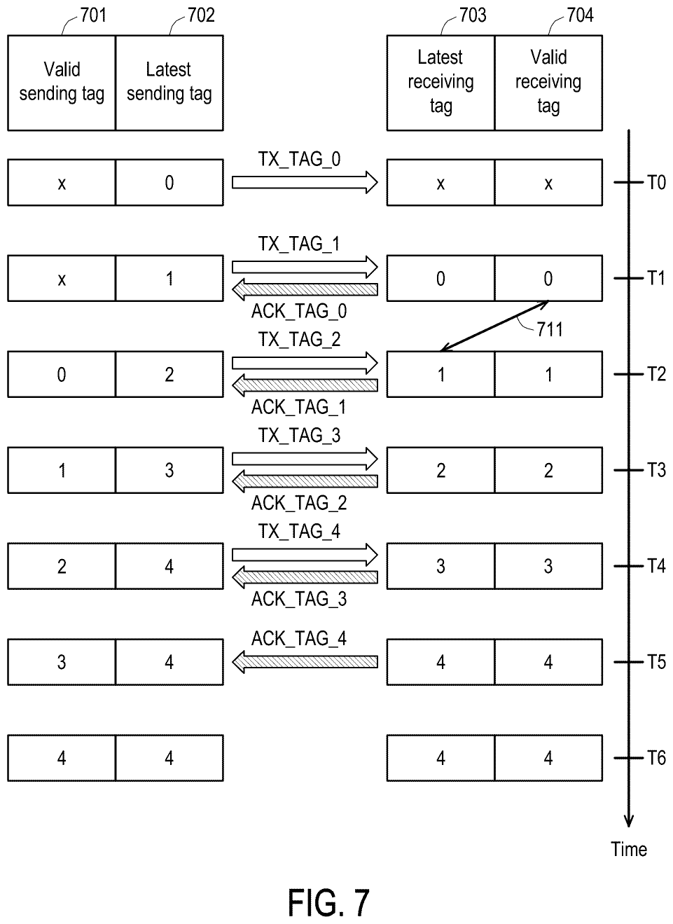

FIG. 7 shows a schematic diagram of a sending frame and a corresponding tag according to a first scenario. Please refer to FIG. 6 and FIG. 7. In FIG. 7, a valid sending tag 701, a latest sending tag 702, a latest receiving tag 703, and a valid receiving tag 704 are shown. The valid sending tag 701, the latest receiving tag 703, and the valid receiving tag 704 are initialized to null values, represented as “x” in the figure. The latest sending tag 702 refers to the tag of the latest operation frame sent by the first device 110. The latest receiving tag 703 refers to the tag of the latest operation frame received by the second device 120. FIG. 7 also marks time points T0 to T6 from top to bottom sequentially. The arrows from left to right represent the frames sent by the first device 110 to the second device 120, and the arrows from right to left represent the frames sent by the second device 120 to the first device 110. “TX_TAG_0” represents an operation frame with a tag of 0, “TX_TAG_1” represents an operation frame with a tag of 1, and so on. “ACK_TAG_0” represents a reply frame with a tag of 0, “ACK_TAG_1” represents a reply frame with a tag of 1, and so on.

At time point TO, the first device 110 sends an operation frame with a tag of 0 to the second device 120, and at the same time sets the latest sending tag 702 to 0. The second device 120 does not update the latest receiving tag 703 until the next time point. At time point T1, the first device 110 sends an operation frame with a tag of 1 to the second device 120, and the second device 120 sets the latest receiving tag 703 to 0. The second device 120 determines the difference between the latest receiving tag 703 at time point T1 and the valid receiving tag 704 at time point TO. Since the valid receiving tag 704 is null at this time, the difference may be set to 1, so that the second device 120 enters state 615, the reply frame with a tag of 0 is sent to the first device 110, and the valid receiving tag 704 is updated to 0. At time point T2, since the first device 110 receives the reply frame with a tag of 0, the first device 110 sets the valid sending tag 701 to 0 and continues to send an operation frame with a tag of 2 to the second device 120. Also, at time point T2, referring to calculation 711, the difference between the two tags at this time is 1, so the second device 120 enters state 615 and sends a reply frame with a tag of 1 to the first device 110.

In the scenario of FIG. 7, no frames are lost. The first device 110 sequentially generates operation frames with tags from 0 to 4. It is worth noting that the first device 110 does not need to wait for a reply frame before continuing to send the next operation frame. In other embodiments, the valid receiving tag 704 may also be initialized to −1.

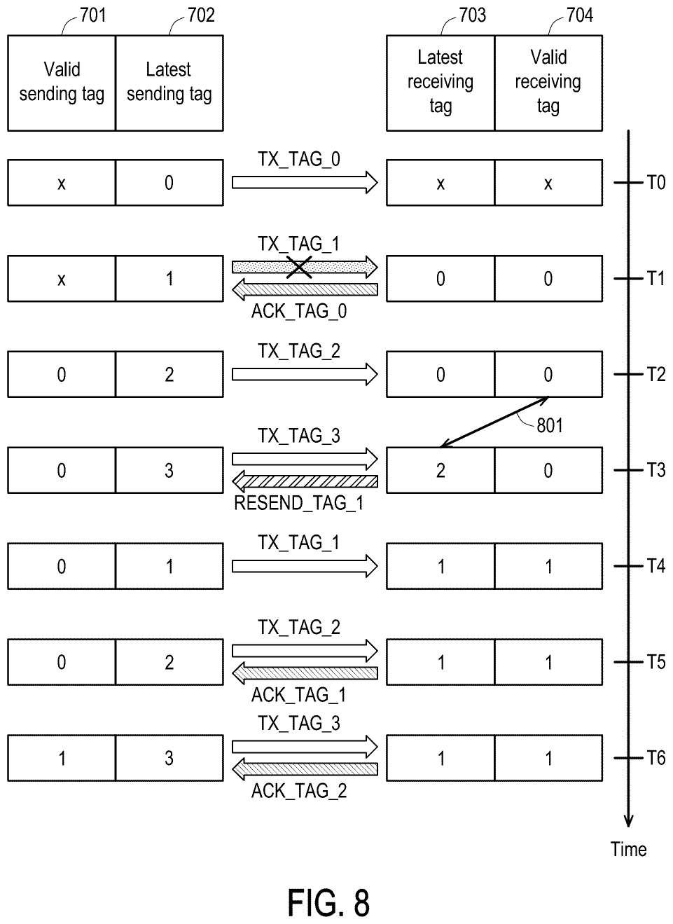

FIG. 8 shows a schematic diagram of a sending frame and a corresponding tag according to a second scenario. Referring to FIG. 8, at time point T1, the first device 110 sends an operation frame with a tag of 1 to the second device 120, but the operation frame is lost. Since no operation frame with a tag of 1 is received, the second device 120 does not update the valid receiving tag 704 to 1, and the second device 120 is in state 616. At time point T2, the first device 110 continues to send the operation tag with a tag of 2 to the second device 120, and the second device 120 returns to state 614. At time point T3, please refer to calculation 801. The second device 120 calculates the difference between tag “2” and tag “0”. Since the difference is greater than or equal to 2, the second device 120 enters state 617. The second device 120 adds 1 to the valid receiving tag 704, and then sends a resend frame with a tag of 1 (denoted as “RESEND_TAG_1”) to the first device 110. After the resend frame is resent, the first device 110 enters state 607 at time point T4 and obtains the corresponding operation frame from the command buffer according to the tag of the resend frame, and the operation frame with a tag of 1 is sent to the second device 120.

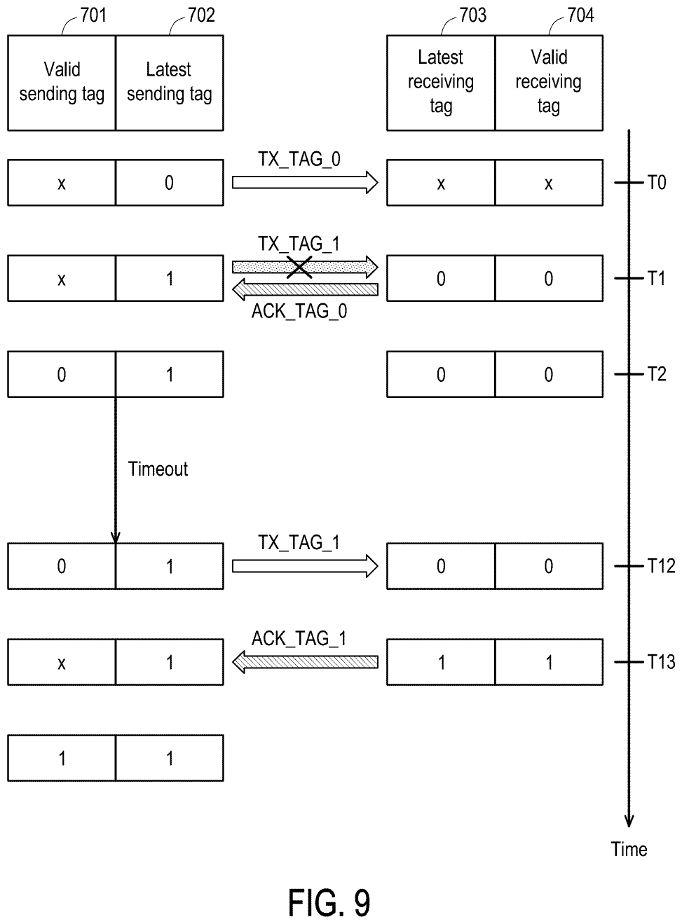

FIG. 9 shows a schematic diagram of a sending frame and a corresponding tag according to a third scenario. At time point T1, the first device 110 sends an operation frame with a tag of 1 to the second device 120, but the operation frame is lost. Different from the situation in FIG. 8, the operation frame with a tag of 1 is the last operation frame, so the second device 120 does not enter state 617 to send the resend frame. In the scenario of FIG. 9, the first device 110 waits for a reply frame with a tag of 1 in state 603. Exceeding 10 time points indicates timeout. At time point T12, the first device 110 is switched from state 603 to state 607 due to timeout, 1 is added to the valid sending tag, and then an operation frame with a tag of 1 is sent to the second device 120.

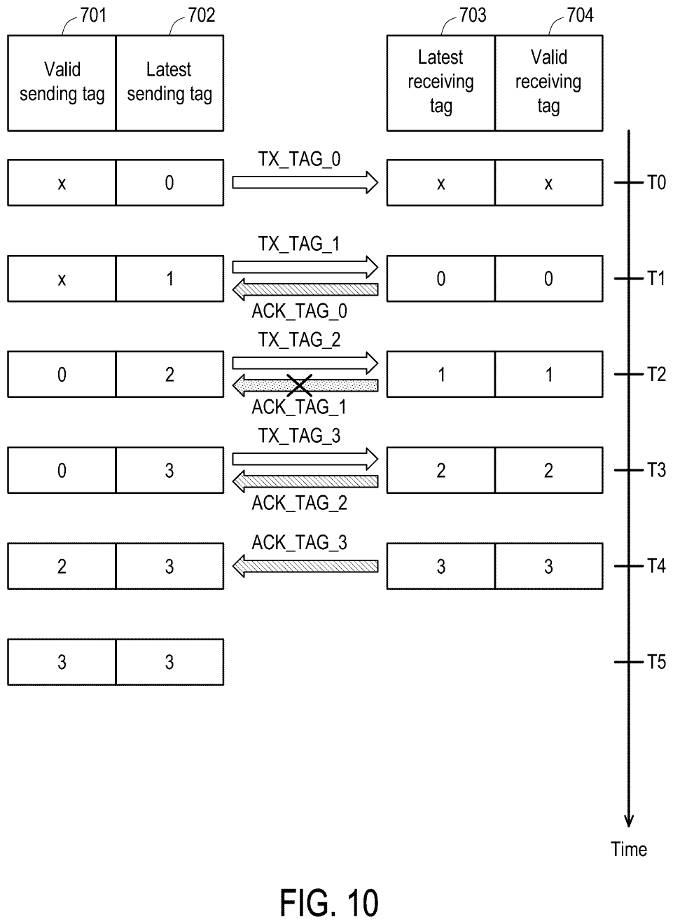

FIG. 10 shows a schematic diagram of a sending frame and a corresponding tag according to a fourth scenario. Please refer to FIG. 10. At time point T2, the second device 120 sends a reply frame with a tag of 1 to the first device 110, but this frame is lost. At time point T3, the second device 120 sends a reply frame with a tag of 2 to the first device 110. After the reply frame is received, at time point T4, the first device 110 updates the valid sending tag 701 to 2. Although the first device 110 does not receive the reply frame with a tag of 1, once the first device 110 receives the reply frame with a tag of 2, the second device 120 has successfully received the operation frames with tags 1 and 2, so there is no issue in directly updating the valid sending tag 701 from 0 to 2.

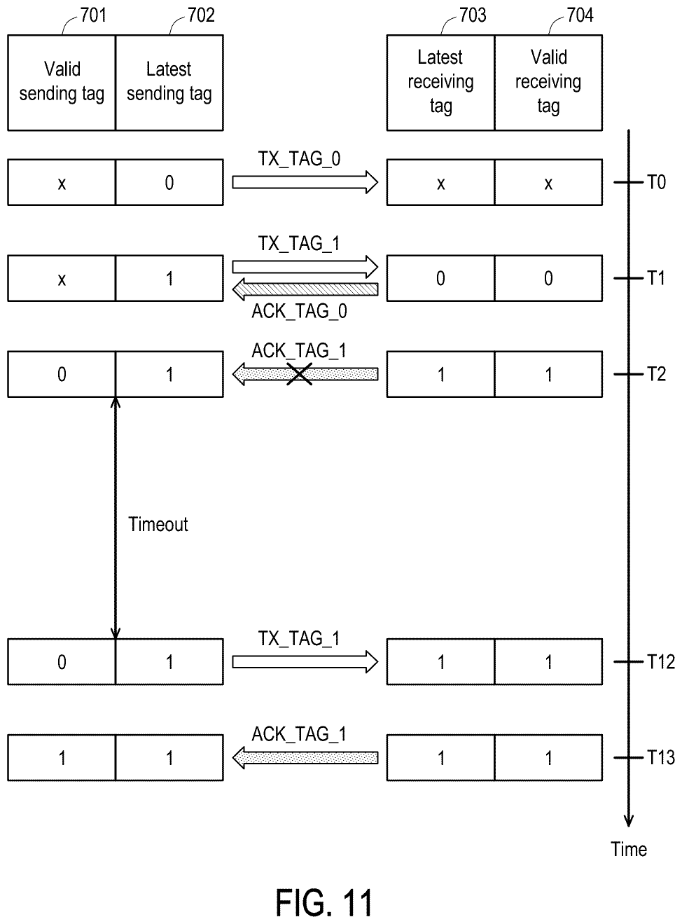

FIG. 11 shows a schematic diagram of a sending frame and a corresponding tag according to a fifth scenario. Please refer to FIG. 11. At time point T2, the second device 120 sends a reply frame with a tag of 1 to the first device 110, but this frame is lost. Since the first device 110 does not receive the reply frame, the timer is not reset. At time point T12, the timer indicates timeout, so the first device 110 adds 1 to the valid sending tag 701, and sends an operation frame with a tag of 1 to the second device 120.

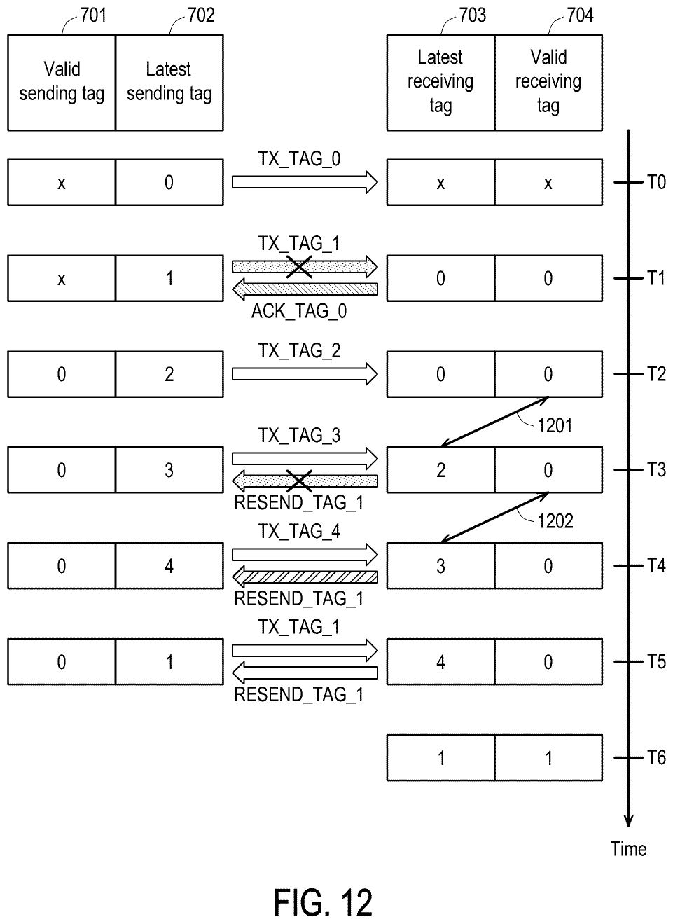

FIG. 12 shows a schematic diagram of a sending frame and a corresponding tag according to a sixth scenario. Please refer to FIG. 12. At time point T1, the first device 110 sends an operation frame with a tag of 1 to the second device 120. However, this frame is lost, so the second device 120 does not update the latest receiving tag 703 accordingly. At time point T3, referring to calculation 1201, the second device 120 calculates the difference between the two tags. Since the difference is 2, the second device 120 sends a resend frame with a tag of 1 to the first device 110, but this resend frame is also lost. At time point T4, referring to calculation 1202, the difference between the two tags is 3, which is still greater than or equal to 2, so the second device 120 sends the resend frame with a tag 1 to the first device 110 again. At time point T5, the first device 110 obtains the operation frame with a tag of 1 from the command buffer and sends the operation frame to the second device 120.

It may be known from the FIGS. 7 to 12 that in all situations, error recovery may be achieved according to the communication method provided in the disclosure.

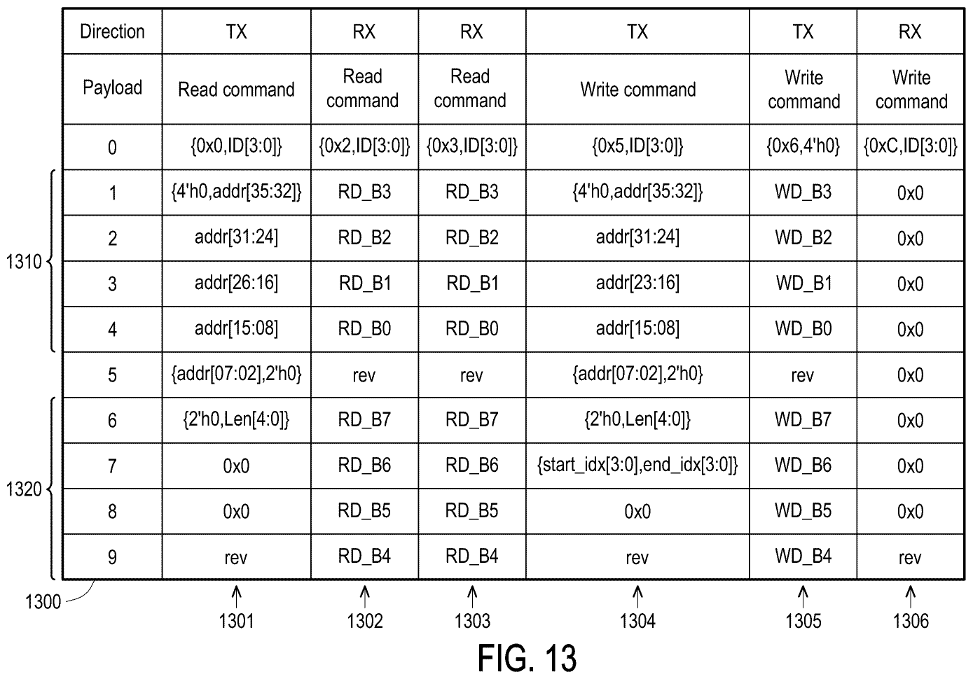

FIG. 13 shows a schematic diagram of a payload in a frame according to an embodiment. Referring to FIG. 13, table 1300 shows frames 1301 to 1306, wherein frames 1301 to 1303 correspond to read commands, and frames 1304 to 1306 correspond to write commands. For simplicity, only 10 payloads are shown for each frame (i.e., the bytes marked “5” to “14” in FIG. 4). Here, the payloads marked “1” to “4” in FIG. 13 are called the first field 1310, and the payloads marked 6 to 9 are called the second field 1320. Moreover, the direction “TX” refers to sending from the first device 110 to the second device 120, which is also the above operation frame; the direction “RX” refers to sending from the second device 120 to the first device 110, which is also the above reply frame. The payload marked “0” records subtypes and identifiers.

When a read command is to be executed, the first device 110 first sends the frame 1301 to the second device 120. The first field 1310 in the frame 1301 is configured to record the read address, and the payload marked “6” is configured to record the data length. After the frame 1301 is received, the second device 120 sends the frames 1302 and 1303 to the first device sequentially, and the first field 1310 and the second field 1320 in the frames 1302 and 1303 are both configured to record the read data. In the existing LTPI data frame, only the second field 1320 in each data frame may be used to record data, thus resulting in a smaller amount of data that may be sent in each frame.

When a write command is to be executed, the first device 110 first sends the frame 1304 to the second device 120. The first field 1310 in the frame 1304 is configured to record the write address, and the payload marked “6” is configured to record the data length. Next, the frame 1305 is sent to the second device 120 after the frame 1304. The first field 1310 and the second field 1320 of the frame 1305 are both configured to record the written data. Next, the second device 120 sends the frame 1306 to the first device to indicate that the data writing is successful. Compared to conventional techniques, the frame 1306 may include more written data.

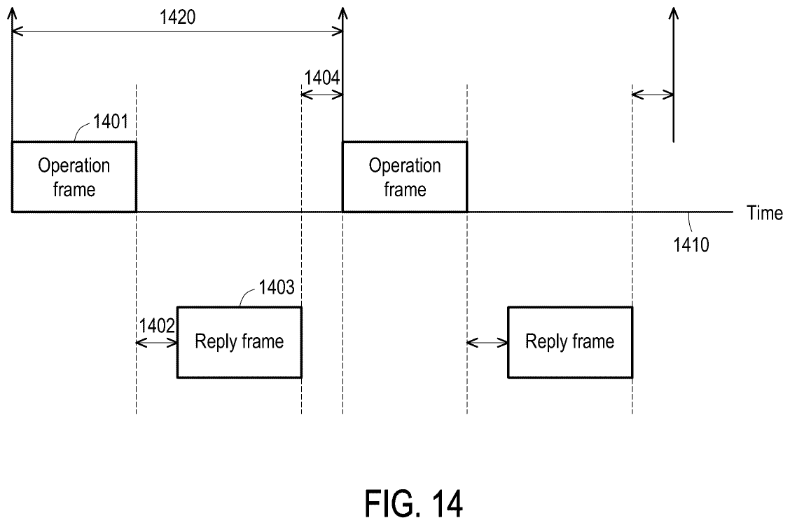

FIG. 14 shows a timing diagram of sending a frame between two devices according to prior art. Referring to FIG. 14, the operation above the timeline 1410 is sending a frame from the first device 110 to the second device 120, and the operation below the timeline 1410 is sending a frame from the second device 120 to the first device 110. In the prior art, the first device 110 needs to receive a reply frame before sending the next operation frame. For example, the first device 110 generates one first operation frame in a time interval 1401. A time interval 1402 represents the time needed for the frame to be sent in the tunnel. In a time interval 1403, the second device 120 generates a reply frame. Then, only after a time interval 1404 passes may the first device 110 generate the next operation frame. Therefore, the first device 110 needs to pass a time interval 1420 before sending the next frame.

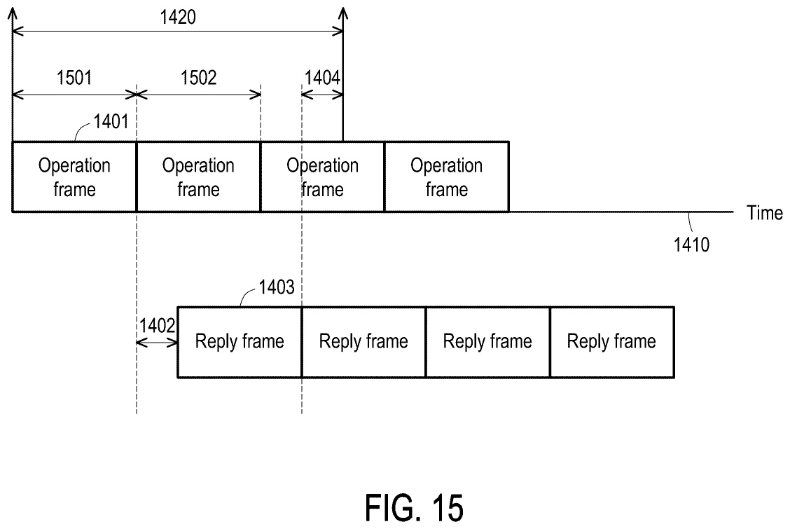

FIG. 15 shows a timing diagram of sending a frame between two devices according to an embodiment. Comparing FIG. 14 with FIG. 15, in the embodiment of FIG. 15, the first device 110 generates a first operation frame in a time interval 1501 and may generate the next operation frame in a time interval 1502 without waiting for a reply frame. In addition, the first device 110 also does not need to wait for the frame to be sent in the tunnel. Therefore, compared with the old method (compare time interval 1420), the above communication method may significantly increase throughput.

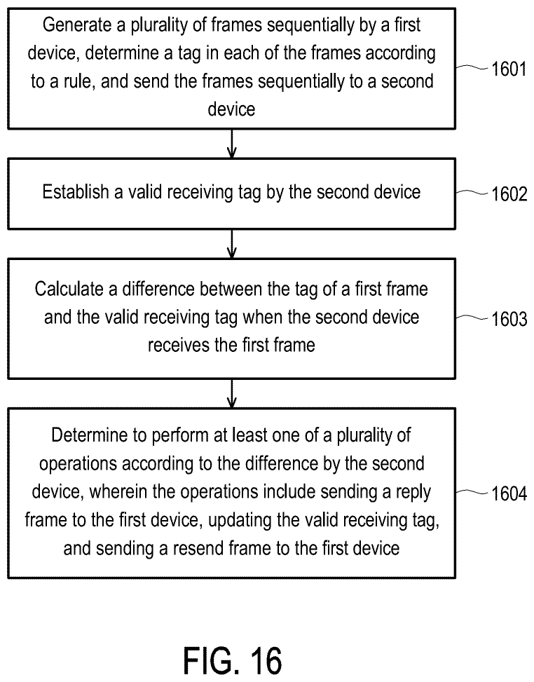

FIG. 16 shows a flowchart of a communication method according to an embodiment. Referring to FIG. 16, in step 1601, a first device sequentially generates a plurality of frames, determines a tag in each frame according to a rule, and sends the frames to a second device sequentially. In step 1602, the second device establishes a valid receiving tag. In step 1603, when the second device receives the first frame, a difference between the tag of the first frame and the valid receiving tag is calculated. In step 1604, the second device determines to perform at least one of a plurality of operations according to the difference. These operations include sending a reply frame to the first device, updating the valid receiving tag, and sending a resend frame to the first device. Each step in FIG. 16 is as described in detail above, and is not repeated herein. It should be mentioned that, each step in FIG. 16 may be implemented as a plurality of program codes or circuits, and the invention is not limited thereto. In addition, the method of FIG. 16 may be used in conjunction with the above embodiments or may be used alone. In other words, other steps may also be added between the steps of FIG. 16. In an embodiment, step 1602 may also be performed before step 1601. The method of FIG. 16 may be applied to the LTPI specification, but in other embodiments, the method of FIG. 16 may also be applied to the specifications of other communication protocols.

According to the above method and system for communication, by setting tags in the frames and operating according to the difference of the tags, the first device may continuously send the frames. These tags may not only achieve the function of error recovery, but also improve throughput.

Although the invention has been described with reference to the above embodiments, it will be apparent to one of ordinary skill in the art that modifications to the described embodiments may be made without departing from the spirit of the disclosure. Accordingly, the scope of the disclosure is defined by the attached claims not by the above detailed descriptions.

What is claimed is:

1. A communication method, adapted for a first device and a second device, the communication method comprising:
generating a plurality of frames sequentially by a first device, determining a tag in each of the frames according to a rule, and sending the frames sequentially to a second device;
establishing a valid receiving tag by the second device;
calculating a difference between the tag of a first frame in the frames and the valid receiving tag when the second device receives the first frame;
determining to perform at least one of a plurality of operations according to the difference by the second device, wherein the operations comprise sending a reply frame to the first device, updating the valid receiving tag, and sending a resend frame to the first device.

2. The communication method of claim 1, further comprising:
establishing a command buffer by the first device and storing the frames sequentially in the command buffer; and
suspending generating the frames by the first device in a case that the command buffer is full.

3. The communication method of claim 2, wherein a size of the command buffer is less than an overflow upper limit, and the overflow upper limit is determined according to a bit number of the tag.

4. The communication method of claim 2, wherein the rule is an increment or a decrement, and the communication method also comprises:
setting a tag in the reply frame equal to the tag of the first frame by the second device, sending the reply frame to the first device, and discarding the first frame in a case that the difference is a first value; and
setting the tag in the reply frame equal to the tag of the first frame by the second device, sending the reply frame to the first device, and setting the valid receiving tag equal to the tag of the first frame in a case that the difference is a second value.

5. The communication method of claim 4, further comprising:
modifying the valid receiving tag according to the rule by the second device to determine a tag of the resend frame and sending the resend frame to the first device in a case that the difference is within a value range excluding the first value and the second value.

6. The communication method of claim 5, further comprising:
establishing a valid sending tag by the first device; and
setting the valid sending tag equal to the tag of the reply frame and removing at least one of the frames in the command buffer according to the tag of the reply frame when the first device receives the reply frame.

7. The communication method of claim 6, further comprising:
obtaining a second frame corresponding to the tag of the resend frame from the command buffer when the first device receives the resend frame; and
sending the second frame to the second device by the first device.

8. The communication method of claim 6, further comprising:
starting a timer by the first device when the first device sends one of the frames;
resetting the timer when the first device receives the reply frame; and
modifying the valid sending tag according to the rule to obtain a first tag, obtaining a second frame corresponding to the first tag from the command buffer, and sending the second frame to the second device when the timer indication has timed out.

9. The communication method of claim 1, wherein the frames conform to an Original Equipment Manufacturer (OEM) frame in a Low-Voltage Differential Signaling (LVDS) Tunneling Protocol and Interface (LTPI).

10. The communication method of claim 9, wherein each of the frames comprises a plurality of first fields and at least one second field, the communication method further comprising:
setting the first fields in the first frame to record a write address and the at least one second field in the first frame to record a data length when the first frame corresponds to a write command; and
setting the first fields and the at least one second field of a second frame sorted after the first frame in the frames to record write data.

11. The communication method of claim 9, wherein each of the frames comprises a plurality of first fields and at least one second field, the communication method further comprising:
setting the first fields in the first frame to record a read address and the at least one second field in the first frame to record a data length when the first frame corresponds to a read command; and
sending a second frame to the first device by the second device, wherein a plurality of first fields and at least one second field in the second frame record read data.

12. A communication system, comprising:
a first device configured to generate a plurality of frames sequentially and determine a tag in each of the frames according to a rule; and
a second device communicatively connected to the first device,
wherein the first device is configured to send the frames sequentially to the second device,
the second device is configured to establish a valid receiving tag,
when the second device receives a first frame in the frames, the second device is configured to calculate a difference between the tag of the first frame and the valid receiving tag,
the second device is configured to determine to perform at least one of a plurality of operations according to the difference, wherein the operations comprise sending a reply frame to the first device, updating the valid receiving tag, and sending a resend frame to the first device.

13. The communication system of claim 12,
wherein the first device is configured to establish a command buffer and store the frames sequentially in the command buffer,
in a case that the command buffer is full, the first device is configured to suspend generating the frames.

14. The communication system of claim 13, wherein a size of the command buffer is less than an overflow upper limit, and the overflow upper limit is determined according to a bit number of the tag.

15. The communication system of claim 13, wherein the rule is an increment or a decrement,
in a case that the difference is a first value, the second device is configured to set a tag of the reply frame equal to the tag of the first frame, send the reply frame to the first device, and discard the first frame,
in a case that the difference is a second value, the second device is configured to set the tag in the reply frame equal to the tag of the first frame, send the reply frame to the first device, and set the valid receiving tag equal to the tag of the first frame.

16. The communication system of claim 15,
wherein in a case that the difference is within a value range excluding the first value and the second value, the second device is configured to modify the valid receiving tag according to the rule to determine a tag of the resend frame and send the resend frame to the first device.

17. The communication system of claim 16,
wherein the first device is configured to establish a valid sending tag,
when the first device receives the reply frame, the first device is configured to set the valid sending tag equal to the tag of the reply frame and remove at least one of the frames in the command buffer according to the tag of the reply frame.

18. The communication system of claim 17,
wherein when the first device receives the resend frame, the first device obtains a second frame corresponding to the tag of the resend frame from the command buffer, and sends the second frame to the second device.

19. The communication system of claim 17,
wherein when the first device sends one of the frames, the first device is configured to start a timer,
when the first device receives the reply frame, the first device is configured to reset the timer,
when the timer indication has timed out, the first device modifies the valid sending tag according to the rule to obtain a first tag, obtains a second frame corresponding to the first tag from the command buffer, and sends the second frame to the second device.

20. The communication system of claim 12, wherein the frames conform to an Original Equipment Manufacturer (OEM) frame in a Low-Voltage Differential Signaling (LVDS) Tunneling Protocol and Interface (LTPI).

21. The communication system of claim 20, wherein each of the frames comprises a plurality of first fields and at least one second field,
when the first frame corresponds to a write command, the first device is configured to set the first fields in the first frame to record a write address and the at least one second field in the first frame to record a data length,
for a second frame sorted after the first frame in the frames, the first device is configured to set the first fields and the at least one second field of the second frame to record write data.

22. The communication system of claim 20, wherein each of the frames comprises a plurality of first fields and at least one second field,
when the first frame corresponds to a read command, the first device is configured to set the first fields in the first frame to record a read address and the at least one second field in the first frame to record a data length,
wherein the second device is configured to send a second frame to the first device, and a plurality of first fields and at least one second field in the second frame record read data.
